(19) United States
(12) Patent Application Publication
(10) Pub. No.: US 2004/0233873 A1
(43) Pub. Date: Nov. 25, 2004

(54) Multiple access method for sharing pseudo-noise code by time division transmission in wireless telemetry system

(76) Inventors: Hwang Lee, Seoul (KR); Jae-Seok Kim, Goyang Gyunggi (KR); Gun-Hee Han, Goyang Gyunggi (KR); Kyung-Duk Kim, Seoul (KR); Seong-Joo Lee, Seoul (KR); Kun-II Choe, Paju Gyunggi (KR)

Correspondence Address: GWIPS, PETER T. KWON, 1600-3 SEOCHO-DONG, SEOCHO-GU,, DAELIM BUILDING, 9TH FLOOR, SEOUL, 137-877, KR

(21) Appl. No.: 10/490,527

(22) PCT Filed: Feb. 28, 2002
(86) PCT No.: PCT/KR02/00343

(30) Foreign Application Priority Data
Sep. 20, 2001 (KR) 2001-58249

(51) Int. Cl. H04B 7/216

(52) U.S. Cl. 370/335; 370/342

(57) ABSTRACT

Disclosed is a multiple access method for sharing pseudo-noise code by time division transmission in wireless telemetry system, which transmits same time information from a CU (Control Unit) to all RT (Remote Terminal), and each RT transmits data by time division using the time information provided by the CU. Also, each RT decides the respective transmission time using the time information provided by the CU. After each RT transmits data by time division, if the transmitted data has an error, each RT transmits data by time division in repsonse to the retransmission request of the CU.

### TECHNICAL FIELD

The present invention relates to a multiple access method for a wireless telemetry system, in which multiple remote measuring terminals transmit data to a single central processing unit by sharing PN (pseudo-noise) code.

### BACKGROUND ART

According to CDMA (code division multiple access), multiple users can simultaneously transmit data through the same frequency, by using PN (pseudo-noise) code. However, in a system for mobile telecommunication services, such as IS-95, since PN code must be assigned to unspecified users whenever they request a service, it is impossible to divide a particular PN code into regular time intervals. Moreover, in conventional mobile telecommunication services, since most of the users request a service irregularly, a base station must manage PN code for multiple access, and it is necessary to have a complicated call process for dealing with calls of unspecified users.

Meanwhile, “a wireless telemetry system” according to the present invention means a system that multiple remote measuring terminals (e.g., pulsimeters installed at sickbeds) wirelessly send measured data to a single central processing unit (e.g., a monitoring room for patient observation). This wireless telemetry system may be chosen for a medical or industrial use.

To implement the wireless telemetry system, a central processing unit must simultaneously receive a plurality of remote measuring terminals, each of which has a relatively simple structure. Thus, adapting a conventional CDMA technology to this wireless telemetry system gives a big burden on a central processing unit.

### DISCLOSURE OF INVENTION

To solve the above problem in a conventional CDMA wireless telemetry system, it is an object of the present invention to provide a multiple access method for sharing a PN code by time division transmission in a wireless telemetry system, in which a plurality of remote measuring terminals (RTs) wirelessly send measured data to a single central processing unit (CU), the method comprising the steps of:

the CU's transmitting time information to all of the RTs, so that the RTs can perform time division transmission, and

the RT's demodulating the time information from the CU, and transmitting measured data during transmission time assigned to the RT, while stopping transmission during time not assigned to the RTs.

In the above method, the step 1) may further comprise a step of the CU's transmitting control information data to the plurality of RTs, by using a single PN code, and the step 2) may further comprise a step of the RT demodulating data transmitted from the CU for a given time, and performing synchronization against the PN code transmitted from the CU.

In addition, the above method may further comprise the steps of: if errors are found in data that the RT transmits, the CU transmitting to the RT request for re-transmission, and the RT's re-transmitting re-measured data to the CU.

According to another feature of the present invention, there is provided a multiple access method for sharing a PN code by time division transmission in a wireless telemetry system, in which a plurality of remote measuring terminals (RTs) wirelessly send measured data to a single central processing unit (CU), the method comprising the steps of:

when the RT is initially installed to the wireless telemetry system, the RT's synchronizing the K number of PN codes transmitted from the CU by demodulating a pilot channel and a time information channel broadcast from the CU, and setting a time information in the CU,

the RT's checking whether or not the set time at the step 1) is pre-determined RT enable time, and, if it is not the RT enable time, electricity supply being blocked to power the RT off, otherwise, measured data being transmitted to the CU by the RT in a manner of time division, using the K number of PN codes,

after the RT transmitting the measured data to the CU, the RT's going into a demodulation waiting state for given times, and re-transmitting re-measured data to the CU when the RT receives from CU a request for re-transmission, otherwise, RT's going into a disabled (or sleep) state,

repeating the step 3) by the RT, using an internal timer in the RT.

In the above, the number of PN codes, K, is one. The time information channel of the step 1) may comprise a total of 11 bits, including 5 bits for a minute and 6 bits for a second characterized in that 64 seconds corresponds to 1 minute. The RT enable time of the step 2) may include a frame transmission time required for data transmission from the RT to the CU, and a demodulation wait time required for the RT to demodulate data transmitted from the CU to verify whether or not there are errors in the transmitted data.

The data transmitted from the RT to the CU comprises a preamble for synchronizing with PN code from the RT, a pilot symbol for estimating data channels, a cyclic prefix for synchronizing a frame transmitted from the RT, and an information data measured by the RT using various sensors.

In the above, the cyclic prefix is made by copying the lower 8 bits of the information data.

The above and other objects, features and advantages of the present invention will become more apparent from the following description when taken in conjunction with the accompanying drawings.

### BRIEF DESCRIPTION OF DRAWINGS

FIG. 1 is a timing diagram roughly showing that N remote measuring terminals transmit data by using a PN code, in the manner of time division,

FIG. 2 shows configuration of data channels that are transmitted by a central processing unit to control N remote measuring terminals.

FIG. 3 shows configuration of data channels that are transmitted by each the remote measuring terminal to a central processing unit,

FIG. 4 shows a protocol for initial operation of each the remote measuring terminals when it is installed in the wireless telemetry system.

FIG. 5 shows a protocol for normal operation of each the remote measuring terminals, and

FIG. 6 shows a protocol for achieving re-transmission when each the remote measuring terminal fails in transmitting data.

### PREFERRED EMBODIMENTS FOR CARRYING OUT THE INVENTION

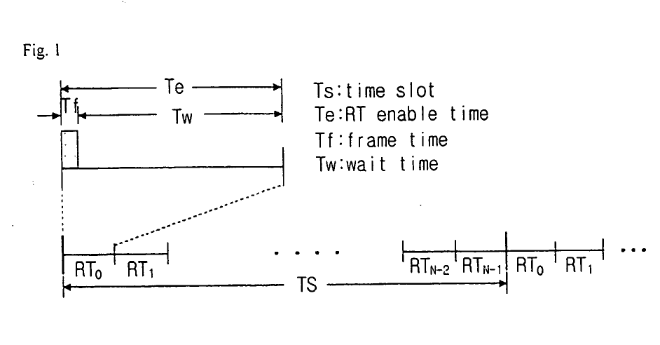

Preferred embodiments will be described herein below with reference to the accompanying drawings. FIG. 1 is a timing diagram for time division transmission multiple access method according to the embodiment of the present invention.

First, referring to FIG. 1, time slot, Ts, is determined, which is the time intervals that remote measuring terminals (hereinafter referred to as remote terminals, RT) must periodically transmit data. The time slot, Ts, can be determined flexibly according to the RT application field.

After the time slot is determined, RT enable time, Te, which is the time required for enabling the RTs to transmit or receive data, is determined. Each of the RTs is supplied with electrical energy during RT enable time, Te, assigned to each; while during the remaining time RTs stop working and fall into a sleep mode due to electrical energy supply suspension. The RT enable time can be divided into two: one is frame transmission time, Tf, required for data transmission, the other is demodulation wait time, Tw, required for waiting data from a central processing unit. During Tf, RT transmits data to a central processing unit (referred to as CU), and during Tw, RT demodulates data transmitted from CU to verify the transmitted data.

According to FIG. 1, a total of n RTs can transmit data by using time division in a unit time slot, Ts. After the lapse of one time slot, that is, after 0'th to (N−1)'th RT sequentially transmit data, another new time slot, Ts, processes again. At this time, n RTs transmit data using only a single PN code, and therefore CU requires only a single PN code to be transmitted to the respective RTs. The number of RTs, RT_{N}, which can transmit data by means of only a single PN code, can be determined by Eq. 1 below. Thus, if the number of PN code is “K”, RTₜₒₜₐₗ of RTs can transmit data as in Eq. 2.

$$\begin{matrix}{RT}_{N} = Ts \times \frac{64}{Te} & ⟨ Eq . 1 ⟩ \\ {RT}_{total} = K \times {RT}_{N} = K \times Ts \times \frac{64}{Te} & ⟨ Eq . 2 ⟩\end{matrix}$$

For example, if Te is 8 seconds and Ts is 16 minutes, then 128 RTs can transmit data using single PN code; if using 10 PN codes at a time, 1280 RTs can transmit data.

In FIG. 1, the RT enable time that each RT transmits data is pre-set by the number of RTs, RT_{N}. The method of setting data transmission time, or the RT enable time is determined by Eq. 3 to Eq. 5.

$$\begin{matrix}Transmission time ( T ) = ( {T}_{2} : {T}_{1} ) & ⟨ Eq . 3 ⟩ \\ {T}_{1} = rem ( {RT}_{N} , \frac{64}{Te} ) \times \frac{64}{Te} & ⟨ Eq . 4 ⟩ \\ {T}_{2} = quot ( {RT}_{N} , \frac{64}{Te} ) & ⟨ Eq . 5 ⟩\end{matrix}$$

Here, “rem(x,y)” stands for a remainder when x is divided by y, “quot(x,y)” stands for the quotient when x is divided by y, “T” denotes the RT's data transmission time. “T₁” denotes a low level time(e.g., second) of the transmission times, “T₂” denotes a high level time(e.g., minute) of the transmission times, “RTN” means RT numbers, and “Te” means the RT enable time that shows transmission time intervals between RTs. Even though the unit of “T₁” is second and the unit of “T₂” is minutes unlike the ordinary clock system 64T, corresponds to T₂ in the present invention because of considering hardware design aspect.

In the above Equations, Te has the form of 2^{x}. Therefore, Eq. 4 and Eq. 5 can be easily implemented by hardware. For example, suppose a wireless telemetry system which uses single PN code and whose Te is 8 seconds and Ts is 16 minutes. Then total 128 RTs can transmit data, and among these the 100th RT can transmit data at every 12:32 (12 minutes and 32 seconds) during 16 minutes of repetitive periods.

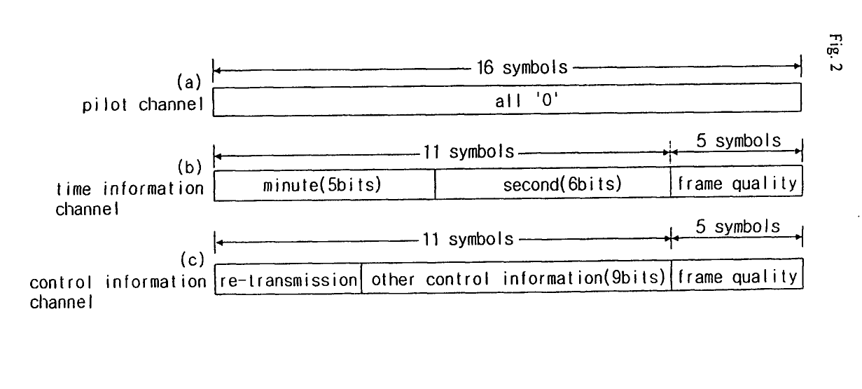

FIG. 2 shows channel configuration diagrams, which is transmitted from CU to RT in order to show RT the transmission time. In FIG. 2, CU transmits to all RTs a pilot channel (a) and a time information channel (b). The pilot channel (a) assists RT in synchronizing the PN code transmitted from CU. The time information channel (b) transmits to the respective RTs the current time information, which the minimum transmission time unit is one second (1 minute=64 seconds). The time information channel (b) comprises a total of 11 bits, in which the upper 5 bits represent a minute and the lower 6 bits represent a second. Therefore, the longest time slot that can be set becomes 32 minutes.

The respective RTs have an internal timer. By using the timer, each of the RTs can determine its transmission enable time (or wake-up time) and sleep time.

Referring to FIG. 2, CU can transmit a control information channel (c) along with the pilot channel (a) and the time information channel (b). The control information channel (c) comprises a total of 11 bits including 2 bits of control bits that determine re-transmission. If there are errors in the data transmitted from RT, CU includes an error signaling control bits in the control information channel (c). After RT receives the request for data re-transmission, RT re-transmits to CU the re-measured data. The remaining bits of the control information channel (c) can be arbitrarily designed according to the system requirement items.

In FIG. 2, the pilot channel (a) and the time information channel (b) are the channels for broadcasting, which always broadcast all of the RTs, and the control information channel (c) is transmitted only to the enabled RT.

Since RT demodulates the control information channel (c) when it is enabled, it is unnecessary for RT to spread the control information channel (c) using PN codes different from the respective RTs. Therefore, CU assigns single PN code to the pilot channel (a) the time information channel (b), and the control information channel (c), respectively, and spreads them.

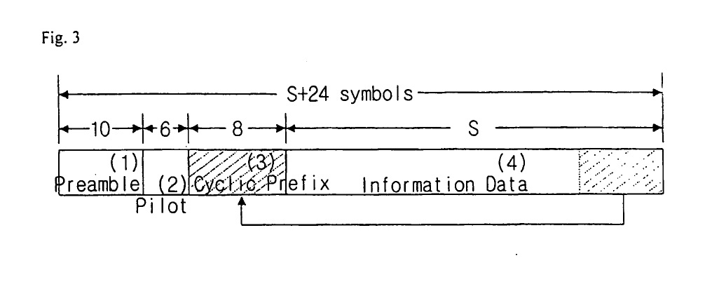

FIG. 3 shows a data channel configuration, which is transmitted to CU from RT. The respective RTs use the data channel as in FIG. 3 in order to transmit measured data to CU. The data channel generally comprises a preamble 1, a pilot symbol 2, a cyclic prefix 3, and an information data 4. The preamble 1 is the data, which is synchronized with PN code from RT, by CU. The pilot symbol 2 is used for estimating channels. The cyclic prefix 3 is a symbol data for synchronizing the frame transmitted from RT. The information data 4 is the information data that RT measured using various sensors. Here, the cyclic prefix 3 is made by copying the lower 8 bits of the information data 4. n RTs spreads data channels using the same PN code, not their unique PN codes.

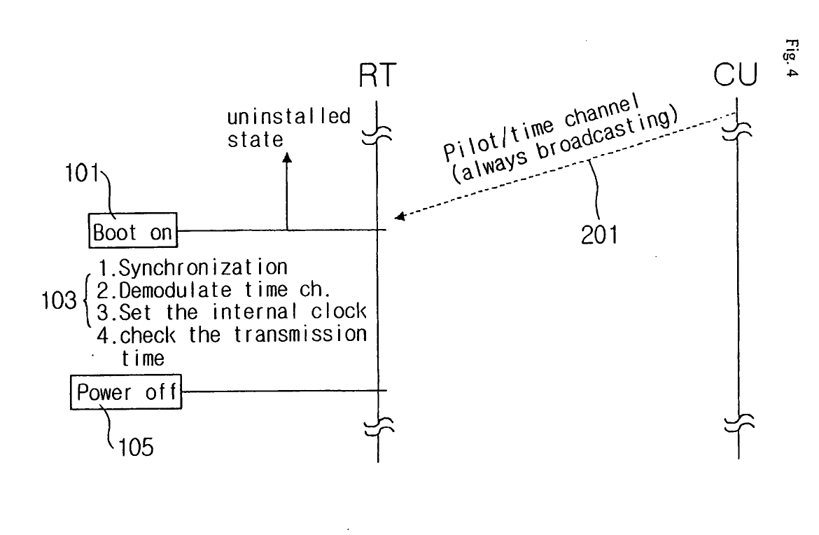

FIG. 4 shows a protocol for initial operation of each RT when it is installed in the wireless telemetry system. When RT is initially installed to the wireless telemetry system (boot-on state) [101], RT synchronizes PN code transmitted from CU by demodulating the pilot channel and the time information channel always being broadcast from CU [201], and set the current time information into the internal timer [103]. The internal timer checks whether or not the current time corresponds to the transmission time [103]. If the transmission time is detected, RT transmits data, otherwise, electricity supply is blocked to power RT off [105].

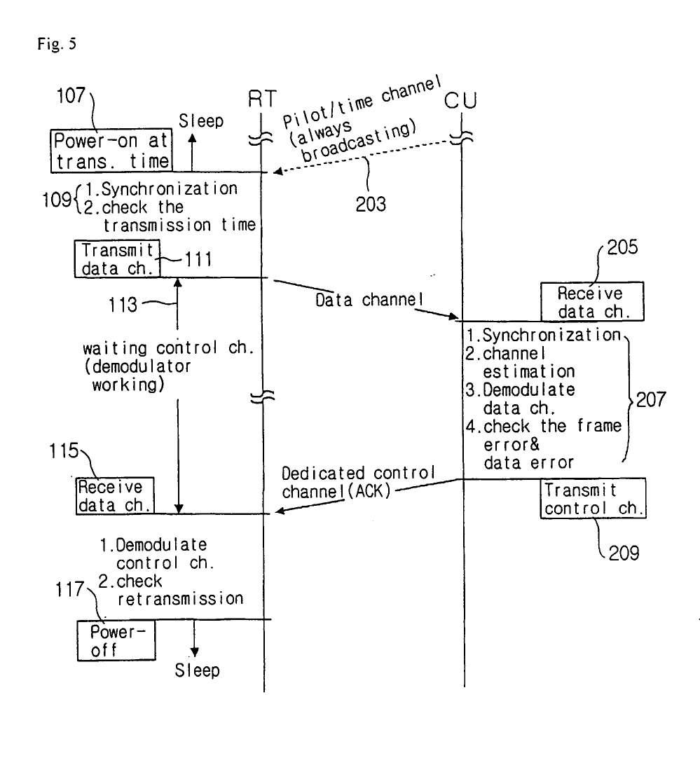

FIG. 5, following FIG. 4, shows a process of enabling RT that has been in disabled (or sleep) state, and a process of re-transmitting when the error-bearing data is received. When the internal timer of RT in a sleep state reaches the pre-determined transmission time, RT is powered on [107], and RT carries out PN code synchronization [109] by demodulating the pilot channel from CU [203]. After synchronization, RT transmits measured data to CU by using data channel [111]. CU receives the data channel [205] and first, to demodulate it, carries out PN code synchronization by using the preamble 1 as explained in FIG. 3 [207]. After PN code synchronization, CU performs channel estimation using the pilot symbol referred in FIG. 3, and last demodulates the measured data from RT [207]. If there are no errors in transmitted data, CU transmits to the pertinent RT the control information that notifies “No errors”, through the control information channel [209]. Meanwhile, after RT transmits the measured data to CU [111], it goes into the demodulation waiting state for given times [113] until it receives the control information from CU. As soon as RT receives from CU the information that there are no errors in the transmitted data [115], all of the system energy supply is suspended and RT goes into the disabled (or sleep) state [117].

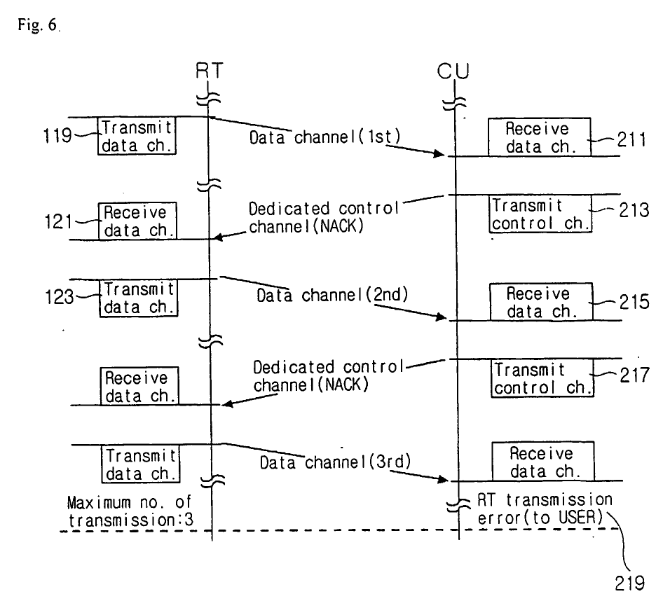

FIG. 6 shows a protocol for performing re-transmission when there are errors in the measured data that RT transmitted. First, when enabled RT transmits the measured data to CU [119], CU receives it [211]. If errors are found in CU received data, CU transmits to RT the control information channel to request re-transmission [213]. RT that has received the request for re-transmission [121] re-transmits the re-measured data to CU [123, 215]. However, there are errors in this data too, CU requests again RT to re-transmit the data [217]. This process can repeat maximum 3 times. If even the third transmission fails, CU notifies the system of data transmission fail [219].

From the foregoing, time division multiple access method according to the present invention, unlike the conventional CDMA method is very suitable for a system having multiple remote measuring terminals (RTs), since a single PN code can be shared by multiple RTs by transmitting data only at a given time under the pre-scribed rule. That is, according to the algorithm of the present invention, one RT does not monopolize a single PN code, and instead, a plurality of RTs share a single PN code for transmitting data, by using a pre-scribed PN code occupation time decision method, which determines PN code occupation time at regular intervals. Therefore, by using this invention, the system capacity can be increased as much as

$$K \times Ts \times \frac{64}{Te}$$

times, as in Eq. 2. This-invention may be most efficient when adapted to the wireless telemetry system in which great many remote terminals should regularly transmit low speed data.

While the invention has been shown and described with reference to a certain embodiment to carry out this invention, it will be understood by those skilled in the art that various changes in form and details may be made therein without departing from the spirit and scope of the invention as defined by the appended claims.

What is claimed is:

1. A multiple access method for sharing a PN code by time division transmission in a wireless telemetry system, in which a plurality of remote measuring terminals (RTs) wirelessly send measured data to a single central processing unit (CU), the method comprising steps of:
1) the CU's transmitting time information to all of the RTs, so that the RTs can perform time division transmission, and
2) the RT's demodulating the time information from the CU, and transmitting measured data during transmission time assigned to the RT, while stopping transmission during time not assigned to the RTs.

2. The method of claim 1, wherein
the step 1) further comprises a step of the CU's transmitting control information data to the plurality of RTs, by using a single PN code, and
the step 2) further comprises a step of the RT demodulating data transmitted from the CU for a given time, and performing synchronization against the PN code transmitted from the CU.

3. The method of claim 1, further comprising steps of:
if errors are found in data that the RT transmits, the CU transmitting to the RT request for re-transmission, and
the RT's re-transmitting re-measured data to the CU.

4. The method of claim 1, wherein the RT's data transmission time is determined by following equations:
$$\begin{matrix}transmission time ( T ) = ( {T}_{2} : {T}_{1} ) \\ {T}_{1} = rem ( {RT}_{N} , \frac{64}{Te} ) \times \frac{64}{Te} \\ {T}_{2} = quot ( {RT}_{N} , \frac{64}{Te} )\end{matrix}$$
Here. “rem(x,y)” stands for a remainder when x is divided by y, “quot(x,y)” stands for a quotient when x is divided by y, “T” denotes the RT's data transmission time, “T₁” denotes a low level time of the transmission time, “T₂” denotes a high level time of the transmission time, “RT_{N}” means the number of RTs, and “Te” means the RT enable time that shows transmission time intervals between the RTs.

5. A multiple access method for sharing a PN code by time division transmission in a wireless telemetry system, in which a plurality of remote measuring terminals (RTs) wirelessly send measured data to a single central processing unit (CU), the method comprising steps of:
1) when the RT is initially installed to the wireless telemetry system, the RT's synchronizing the K number of PN codes transmitted from the CU by demodulating a pilot channel and a time information channel broadcast from the CU, and setting a time information in the CU,
2) the RT's checking whether or not the set time at the step 1) is pre-determined RT enable time, and, if it is not the RT enable time, electricity supply being blocked to power the RT off, otherwise, measured data being transmitted to the CU by the RT in a manner of time division, using the K number of PN codes,
3) after the RT transmitting the measured data to the CU, the RT's going into a demodulation waiting state for given times, and re-transmitting re-measured data to the CU when the RT receives from CU a request for re-transmission, otherwise, RT's going into a disabled (or sleep) state,
4) repeating the step 3) by the RT, using an internal timer in the RT.

6. The method of claim 5, wherein the RT enable time is determined by following equations:
$$\begin{matrix}transmission time ( T ) = ( {T}_{2} : {T}_{1} ) \\ {T}_{1} = rem ( {RT}_{N} , \frac{64}{Te} ) \times \frac{64}{Te} \\ {T}_{2} = quot ( {RT}_{N} , \frac{64}{Te} )\end{matrix}$$
Here, “rem(x,y)” stands for a remainder when x is divided by y, “quot(x,y)” stands for a quotient when x is divided by y, “T” denotes the RT's data transmission time, “T₁” denotes a low level time of the transmission time, “T₂” denotes a high level time of the transmission time, “RT_{N}” means the number of RTs, and “Te” means the RT enable time that shows transmission time intervals between the RTs.

7. The method of claim 5, wherein the number of PN codes, K, is one.

8. The method of claim 5, wherein the time information channel of the step 1) comprises a total of 11 bits, comprising 5 bits for a minute and 6 bits for a second characterized in that 64 seconds corresponds to 1 minute.

9. The method of claim 5, wherein the RT enable time of the step 2) includes a frame transmission time required for data transmission from the RT to the CU, and a demodulation wait time required for the RT to demodulate data transmitted from the CU to verify whether or not there are errors in the transmitted data.

10. The method of claim 5, wherein the data transmitted from the RT to the CU comprises a preamble for synchronizing with PN code from the RT, a pilot symbol for estimating data channels, a cyclic prefix for synchronizing a frame transmitted from the RT, and an information data measured by the RT using various sensors.

11. The method of claim 10, wherein the cyclic prefix is made by copying the lower 8 bits of the information data.
